(19) United States
(12) Patent Application Publication
(10) Pub. No.: US 2014/0206310 A1
(43) Pub. Date: Jul. 24, 2014

(54) MOBILE DEVICE WITH ENHANCED PERSONAL INFORMATION MANAGEMENT APPLICATION FOR TRACKING USER INTERACTIONS

(71) Applicant: 6989837 CANADA LTD., Richmond Hill (CA)

(72) Inventors: Michael Justin Bluestein, Maple (CA); Jonathan Matthew Stern, Maple (CA)

(73) Assignee: 6989837 CANADA LTD., Richmond Hill (CA)

(21) Appl. No.: 14/159,761

(22) Filed: Jan. 21, 2014

Related U.S. Application Data
(60) Provisional application No. 61/754,806, filed on Jan. 21, 2013.

(51) Int. Cl. H04W 8/20; H04W 12/08

(52) U.S. Cl. CPC H04W 8/205; H04W 12/08
USPC 455/405; 455/411

(57) ABSTRACT

In one aspect, the embodiments generally relate to a mobile device that provides a Personal Information Manager (PIM) application with a tracking module for tracking information associated with a user interaction occurring on the mobile device; and a linking module for communicating with an external service that is unrelated to the PIM application. In operation, the tracking module may be configured to provide the information associated with the user interaction to the linking module, and the linking module may be configured to transmit the information to be processed by the external service. In another aspect, the embodiments generally relate to a method of allowing a mobile device to communicate with a source within a secure network. The method includes: receiving an initiation message from the source within the secure network; awaiting a transmission from the mobile device; receiving the information; and relaying the information by including the information in a reply to the initiation message.

### CROSS-REFERENCE TO RELATED APPLICATION

This application claims the benefit of U.S. Provisional Patent Application No. 61/754,806, filed Jan. 21, 2013, the entire contents of which are hereby incorporated by reference.

### FIELD

The described embodiments relate to mobile devices, and more particularly, mobile devices having a Personal Information Manager (PIM) application.

### BACKGROUND

Mobile devices are often provided with a Personal Information Management (PIM) application that enables users of the mobile devices to organize their personal information. A PIM application may, for example, provide functions such as an email function, a calendar function, a notes function, an address book function and/or a to-do list function.

Mobile devices of this nature may be provided to employees of an organization to assist them in performing their work functions. The PIM application may be linked to a PIM server that supports the operation of the PIM application. The PIM server may store data related to the various functions of the PIM application, and may allow data on the PIM application to be synchronized with data on the PIM server. Examples of a PIM server application include Microsoft Exchange™ or Lotus Domino™.

While the PIM application on the mobile device can typically share data with the PIM server, there may be additional server applications within the secure network of an organization that would benefit from access to the information generated by the PIM application. For example, sales representatives within an organization may desire to track email interactions that are conducted using the PIM application in a Customer Relationship Management (CRM) server application.

There is thus a need for an enhanced PIM application on the mobile device that is capable of providing access to this information to other server applications.

### SUMMARY

In one aspect, some embodiments of the present disclosure provide a mobile device comprising a processor and a memory storing instructions which, when executed by the processor, cause the processor to provide a Personal Information Manager (PIM) application, the PIM application comprising:
a tracking module for tracking information associated with a user interaction occurring on the mobile device; and
a linking module for communicating with an external service unrelated to the PIM application, wherein the external service is capable of processing the information associated with the user interaction;
wherein,
   the tracking module is configured to provide the information associated with the user interaction to the linking module, and
   the linking module is configured to transmit the information to be processed by the external service.

In another aspect, some embodiments of the present disclosure provide a method of tracking user interactions on a mobile device, the method comprising:
receiving, at a Personal Information Manager (PIM) application on the mobile device, an input that initiates a user interaction;
tracking, using the PIM application, information associated with the user interaction;
determining an identifier for data on an external service, the external service being unrelated to the PIM application, and the identifier being associated with the user interaction; and
transmitting the identifier and the information associated with the user interaction to an intermediate server;
wherein the intermediate server relays the information to the external service, and wherein the external service is capable of processing the information associated with the user interaction in conjunction with the data on the external service identified by the identifier.

In another aspect, some embodiments of the present disclosure provide a method of allowing a mobile device to communicate with a source within a secure network, the method comprising:
receiving an initiation message from the source within the secure network;
awaiting a transmission, from the mobile device, of information associated with a user interaction occurring on the mobile device;
receiving the information associated with the user interaction; and
in response to the receiving, relaying the information to the source within the secure network, wherein the relaying is performed by including the information in a reply to the initiation message.

### DRAWINGS

Embodiments of the present invention will now be described in detail with reference to the drawings, in which:

FIG. 1 is a block diagram of a system for providing information associated with a user interaction to an external service, in accordance with an embodiment of the present disclosure;

FIG. 2 is a flowchart diagram illustrating the steps of providing information associated with a user interaction occurring on a mobile device to a CRM application, in accordance with an embodiment of the present disclosure;

FIG. 3 is a flowchart diagram illustrating the steps of providing information associated with a user interaction occurring on a mobile device to a Document Management System (DMS) application, in accordance with an embodiment of the present disclosure;

FIG. 4 is a flowchart diagram illustrating the steps of allowing a mobile device to communicate with a source within a secure network, in accordance with an embodiment of the present disclosure; and

FIGS. 5A-5F are example screenshots of a user interface of a mobile device, when selecting a document from a DMS application, in accordance with various embodiments of the present disclosure.

### DETAILED DESCRIPTION

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor (e.g., a microprocessor), a data storage system (including volatile and non-volatile memory and/or storage elements), at least one input device, and at least one output device. For example and without limitation, the programmable computers may be a personal computer, laptop, personal data assistant, cellular telephone, smartphone device, tablet computer, and/or wireless device. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The subject system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Moreover, the subject system may be implemented as one or more software components stored on one or more computer servers that are accessible via one or more client machines in a client-server architecture. In such case, the system can be considered to be a hosted software offering or a software service employed in a software-as-a-service deployment.

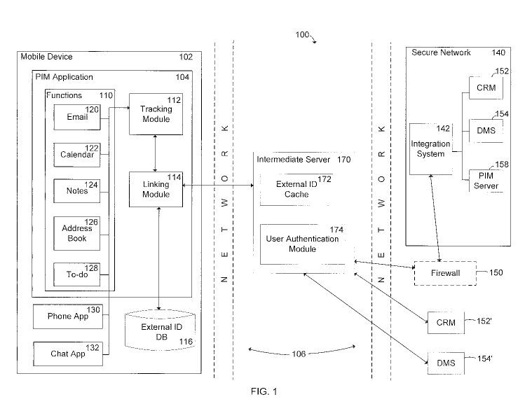

Referring to FIG. 1, shown there generally as 100 is a block diagram of a system for providing information associated with a user interaction to an external service, in accordance with an embodiment of the present disclosure.

The system may include a mobile device 102, a secure network 140 and an intermediate server 170, all communicably connected to each other via network connections 106. Each of these three components will be discussed in turn.

A mobile device 102 may include a processor, memory for storing instructions for execution by the processor, a display, an input device such as a touchscreen, and/or a network interface for data communications. For example, a mobile device 102 may include cellular phones, smartphones (e.g., Apple® iPhone®, BlackBerry®, Android™ devices, or Windows Phone™ devices) or other suitable network-connected computing devices such as a tablet computer (e.g., Apple® iPad™).

The mobile device 102 may include various applications that a user can interact with. These applications may include an enhanced PIM application 104, a phone application 130 and/or a chat application 132, for example. The enhanced PIM application 104 may provide various functions 110 for organizing personal information of the user of the mobile device 102. These functions may include, for example, an email function 120, a calendar function 122, a notes function 124, an address book function 126, and/or a to-do list function 128.

The PIM application 104 may be capable of tracking user interactions occurring on the mobile device and sending information associated with the user interactions to external services. To perform the tracking and sending of this information, the PIM application 104 may be provided with a tracking module 112 and a linking module 114.

A user interaction may generally include any activity or task performed by a user on the mobile device, as may be determined by the invocation or manipulation of a user interface provided on the mobile device 102. For example, the activity or task may include composing an email, conducting a phone call, and/or creating an appointment in a calendar.

As illustrated, the tracking module 112 may be in communication with the various functions 110 of the PIM application 104, as well as with the application(s) not included in the PIM application 104 (e.g., a phone application 130 and/or chat application 132). This allows the tracking module 112 to track user interactions that occur with functions 110 of the PIM application 104, as well as with applications executing on the mobile device 102 that is not provided by the PIM application 104.

Depending on whether the tracking is with respect to a user interaction with a function 110 of the PIM application 104 or with respect to an application not included in the PIM application 104, the operation of the tracking module 112 may differ.

For example, if the tracking module is of functions 110 of the PIM application 104, the tracking module 112 may be able to communicate with the software modules providing the various functions 110 (e.g., such communication may be performed via inter-process communication protocols available on the operating system). The various software modules may correspondingly be configured to communicate with the tracking module 112 to provide the information associated with the user interactions with each respective function 110.

In alternate embodiments, the operations tracking module 112 may be integrated with the software modules providing each of the functions 110. For example, the software modules for one or more of the email function 120, calendar function 122, notes function 124, address book function 126 and to-do list function 128 may be provided with program code that is able to track their respective user interactions, so that the information associated with the user interactions is automatically generated within the software modules for each respective function 110.

If the tracking module 112 is tracking user interactions with respect to an application that is not included in the PIM application 104, the tracking module 112 may not be able to communicate with these outside applications directly. This is because the outside applications are outside the control of the PIM application 104, and may not have been specifically configured to respond to requests for information from, or to provide alerts to, the tracking module 112. The tracking module 112 may, however, be able to access information associated with user interactions with these applications via Application Programming Interfaces (APIs) provided by the operating system.

For example, the operating system may provide an API that allows the tracking module 112 to register for alerts when certain user interactions occur with respect to the phone application 130 (e.g., when a phone call is initiated, or a phone call is terminated). Additionally, the operating system may provide an API that allows the tracking module 112 to access the caller identification (Caller ID) data associated with a phone call. To track user interaction with the phone application 130, the tracking module 112 may then access the Caller ID API upon receiving an alert that a phone call has been initiated or terminated, so as to obtain the caller information associated with a particular phone call. As discussed below, this caller information may then be used to look up an external identifier in the external identifier database 116, for example.

Additional APIs may be available that allows the tracking module 112 to access information about user interactions with the Chat application 132. For example, the BlackBerry™ platform may provide an API that allow the tracking module 112 to determine if a user has been communicating using the BlackBerry Messenger (BBM)™ chat application on a BlackBerry™ device.

It will be understood that depending on the operating system on which the PIM application 104 is provided and/or the type of application that the tracking module 112 is tracking, additional or alternative APIs may be available to be called by the tracking module 112 to determine information associated with a given user interaction.

Once the information associated with the user interaction has been determined, the tracking module 112 may be configured to provide that information to the linking module 114.

As will be understood, the information generated by the tracking module 112 may vary depending on the type and nature of the function 110 (or the application 130, 132 as the case may be) that the user interaction is with and/or the nature of the external service that the information is to be sent to. For example, if the user interaction is the creation of an appointment in the calendar function 122 of the PIM application 104, the generated information associated with the user interaction may include the participants, date/time, subject and/or location of the meeting. In another example where the user interaction is with an email function 120 of the PIM application 104, the generated information may include various details about a composed email (e.g., the contents of the “from”, “to”, “cc”, “bcc”, “subject”, “message-id”, or “uid” header fields of the email, attachments in the email, links embedded in the email, whether such links have been clicked, and/or text from the body of the email). In some embodiments, the tracking module 112 may also be configured to measure the duration of the user interaction, so that the amount of time spent composing the email may also be included in the information that is generated for transmission.

The linking module 114 may be configured to interface with one or more external services that are capable of processing the information associated with the user interaction. While these external services may generally be unrelated to the PIM application 104 in the sense that they were not originally designed to interface with the PIM application 104, they can nevertheless benefit from access to this information. In various embodiments, the external services may be provided within a secure network 140 of an organization. For example, as illustrated, the external services may include a CRM application 152, and/or a Document Management System (DMS) application 154 provided within the secure network 140.

When transmitting the information associated with a user interaction to an external service, the transmitted information may need to include an identifier native to the external service that will allow the external service to accurately process the information. As will be understood, the different external services may each use their own native identifiers. For example, a CRM application 152 may have its own native customer identifiers to identify customer records internal to the CRM application 152. Similarly, a DMS application 154 may have its own native document identifiers to identify documents stored within the DMS application 154. The transmitted information may accordingly include these native identifiers that are to be used by the external services.

To identify the native identifiers, in various embodiments, the PIM application 104 may be provided with an external identifier database 116 that stores a cache of the native identifiers used by the external services. For example, in the case where the external service is a CRM application 152, the external identifier database 116 may store the native customer identifiers (e.g., a customer number) used by the CRM application 152. The linking module 114 may then retrieve a native customer identifier (e.g., the customer number) corresponding to the customer identifier determined by the tracking module 112 when tracking a user interaction.

In a specific example scenario, if the user interaction is an email interaction, the tracking module 112 may determine a customer identifier to be an email address of another party that the user of the mobile device is emailing. However, simply sending information about the user interaction associated with the email address may not be sufficient for the CRM application 152 to process the information. Accordingly, prior to the sending of the information to the CRM application 152, the linking module 114 may look up the native customer identifier in the external identifier database 116 using the customer identifier (e.g., the email address) determined by the tracking module 112. This may allow the linking module 114 to send the native customer identifier along with the information regarding the user interaction to the external service. Details of how the information in the external identifier database 116 are populated and kept up-to-date are discussed below.

The components within the secure network 140 will now be discussed.

The secure network 140 may include a number of external services that are deployed internally by an organization. As mentioned above, some such example services may include a CRM application 152 and/or a DMS application 154. Additionally, the secure network 140 may include a PIM server application 158 that is able to support the normal operation of the PIM application 104 on the mobile device 102.

As will be understood, a CRM application 152 may be a server application that allows individuals within an organization to manage interactions with the organization's current and future customers/clients. As an increasing amount of communication is now occurring on mobile devices, it may be desirable to automatically log information from user interactions occurring on the mobile device that relate to an organization's customer/client in the CRM application 152. Examples of a CRM application 152 may include Microsoft Dynamics CRM™, or products offered by SAP™ or Oracle™.

A DMS application 154 may be a server application that stores electronic documents, and may allow users to track different versions of documents created by different users (e.g., this feature may be called “historical tracking” in some contexts). As will be discussed in greater detail below, during certain user interactions on the mobile device (e.g., when attaching a document to an email), it may be desirable for the mobile device to send a request to retrieve a document that is stored in the DMS application 152. Examples of DMS applications 154 may include OpenText™ and Microsoft Sharepoint™.

Since these external services may not be configured to communicate directly with the linking module 114, an integration system 142 may be installed within the secure network 140 to facilitate communication between the linking module 114 and these various services. The integration system 142 may be configured to receive the information associated with a user interaction, and pass the information onto the appropriate external service at the secure network 140. To do this, the integration system 142 may be configured to be aware of the APIs made available by the external services, so that the integration system 142 may format the information it receives from the linking module 114 appropriately.

Providing an integration system 142 in this manner may be desirable, for example, in scenarios where the APIs provided by the external services are non-uniform or complex. In these scenarios, the integration system 142 may be configured to communicate with the external services using the APIs provided by the specific external services, such that the communication interfaces provided by the intermediate server 170 may be standardized regardless of the type of vendor of the external services within a given secure network 140.

Optionally, in some embodiments, the secure network 140 may be behind a firewall 150 (shown in dotted outline). As will be understood, the firewall 150 may protect the servers within the secure network 140 by preventing unauthorized or unexpected incoming communication from reaching the external services within the secure network 140.

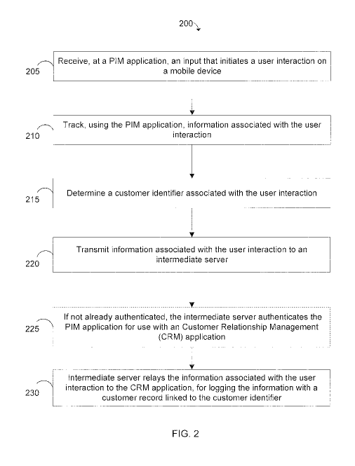

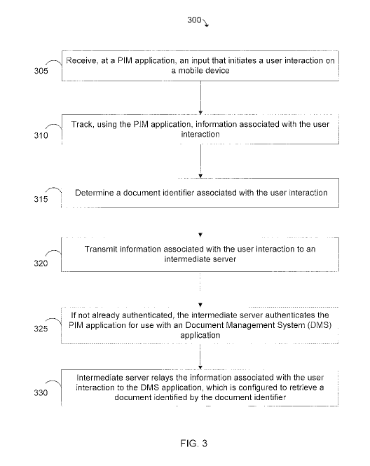

In various embodiments, the external services provided by the organization may not actually reside within the secure network itself. Rather, the external services used by the organization may be provided by a third-party server. As will be understood, such services may be considered to be “cloud-based”. As illustrated in FIG. 1, a cloud-based CRM application 152′ and a cloud-based DMS application 154′ may be present. Examples of cloud-based CRM applications include SalesForce.com™. Examples of cloud-based DMS applications include DropBox™, Google Docs™, Google Drive™, Microsoft SkyDrive™ and/or Apple iCloud™. It will be understood that aspects of the discussion below generally directed to transmitting information to a CRM application 152 (FIG. 2) and a DMS application 154 (FIG. 3) may also be applicable to a cloud-based CRM application 152′ and a cloud-based DMS application 154′ respectively.

The operation of the intermediate server 170 will now be discussed.

The intermediate server 170 may act as an intermediary between the mobile device 102 and the external services. For example, as illustrated, the linking module 114 may communicate with an external service via the intermediate server. That is, the linking module 114 may be configured to transmit the information associated with a user interaction to the intermediate server 170, and the intermediate server 170 may in turn, relay the information to the external service. If the external service is provided within the secure network 140, the information may first be provided through the firewall 150 and the integration system 142. If not, the intermediate server 170 may provide the information to a cloud-based external service directly.

Additionally, in some embodiments, the intermediate server 170 may perform certain support functions. As discussed above, the operations performed by the intermediate server 170 may reduce the processing burden on the external services and/or the mobile device 102, and performance perceived by a user of the mobile device may be enhanced as a result.

For example, as illustrated, the intermediate server 170 may be provided with an external identifier cache 172 that contains data that is similar to the external identifier database 116 on the mobile device 102. As noted, this data may contain the native identifiers used by the external services to refer to internal records of the external services; e.g., a native customer identifier for a CRM application 152 or a native document identifier for a DMS application 154. In some embodiments, the external identifier cache 172 may perform functions (e.g., polling the external services to retrieve any updates or changes to the external identifiers) to keep its cache of native external identifiers up to date. The data in the external identifier database 116 of the mobile device 102 may then be retrieved from the external identifier cache 172 on the intermediate server 170. This offloads the processing tasks associated with keeping the external identifier database 116 up-to-date onto the intermediate server 170. For example, the external services need not respond to inquiries from the potentially-large number of mobile devices that may all send requests to update their external identifier database 116. Instead, the external service need only communicate an update to the intermediate server 170, and the intermediate server 170 may then respond to the requests for updates from the various mobile devices 102 that are requesting to update their external identifier database 116. Moreover, when a new mobile device 102 is first setup, it may need to download the initial batch of external identifiers to populate the external identifier database 116. The mobile device 102 may be configured to retrieve this initial batch of external identifiers from the external identifier cache 172, so that this transmission can be offloaded from the external services to the intermediate server 170 as well.

The intermediate server 170 may also be provided with a user authentication module 174. The user authentication module 174 may perform authentication of the PIM application 104 for use with a given external service. In various embodiments, the intermediate server 170 may require the user authentication to be successful before relaying the information from the mobile device to the external service. By performing the security checks that are necessary prior to allowing the relaying of the information associated with the user interaction to the external service, the processing associated with performing user authentication may also be offloaded from the external service to the intermediate server 170.

The network 106 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. WiMAX), SS7 signaling network, fixed line, local area network, wide area network, and others, including any combination of these.

Referring to FIG. 2, shown there generally as 200 is a flowchart diagram illustrating the steps of providing information associated with a user interaction to a CRM application, in accordance with an embodiment of the present disclosure. Reference will simultaneously be made to the various components described above in FIG. 1.

At step 205, the PIM application 104 may receive an input that initiates a user interaction on a mobile device. This may result from a user interacting with a function 110 of the PIM application 104, or with an application (e.g., the phone application 130 and/or chat application 132) on the mobile device 102.

For the purposes of illustration, an example scenario where the user interacts with the email function 120 of the PIM application 104 will be discussed. In this example scenario, the user initiates a user interaction by activating the email function 110 of the PIM application 104, and selecting to compose an email.

At step 210, the PIM application 104 may track information associated with the user interaction. As discussed above, this step may be performed by the tracking module 112 performing interprocess communication with a software module providing the functions 110 (e.g., the email function 120 providing an alert to the tracking modules 112 to indicate that the user has selected to compose an email) or by accessing an API provided by the operating system of the mobile device 102, for example.

At step 215, a customer identifier associated with the user interaction may be determined. In various embodiments, the tracking module 112 may determine the customer identifier by parsing data generated by the user interaction. For example, continuing on with the example where the user interaction is to compose an email using the email function 110 of the PIM application 104, the tracking module 112 may determine the customer identifier to be an email address that the email is being sent to. In another example, if the user interaction is to create an appointment with a calendar function 122 of the PIM application 104, the customer identifier may include the contents of the “attendees” field of the scheduled meeting (e.g., a text representation of a name, or an email address). In further embodiments, the customer identifier may be the contents of the “location” field for an appointment in a calendar 122.

At step 220, the mobile device 102 may transmit information associated with the user interaction to the intermediate server 170. If the PIM application had not already been authenticated, this transmission may also include credential information that is necessary to perform authentication by the authentication server 170. The credential information may be a username/password combination or a security token that proves that third-party authentication has been performed, for example. In various embodiments, the credential information may be associated with a user profile that is the mobile device 102 has been configured to use.

At step 225, if not already authenticated, the intermediate server 170 may authenticate the PIM application 104 for use with an external CRM application 152. This may involve verifying the credential information provided at step 220. For example, the authentication step may involve decrypting any encrypted credential information, verifying a digital signature, and/or verifying the password provided. Additionally or alternatively, the authentication step may include analyzing the originating Internet Protocol (IP) address of the communication (or the Hypertext Transfer Protocol (HTTP) headers) to determine if the information came from an expected source. Similar analysis may be performed with respect to the geographic location of the mobile device 102. As will be understood, the geographic location of the mobile device 102 may be determined by configuring the linking module 114 to access the geographic location sensors (e.g. a Global Positioning System (GPS) sensor) provided on the mobile device 102.

In various embodiments, authentication may also involve conducting a trend analysis to determine if circumstances surrounding a transmission of information coincide with historical access patterns. For example, if a user only typically accesses a DMS application 154 to retrieve a small number of files (e.g., as may be the case if the DMS application 154 is only typically accessed to retrieve file(s) for attaching to an email), a request to retrieve a very large number of files may raise a security suspicion that the request may be an attempt to steal confidential data.

Furthermore, when performing the authentication, if one or more of the above authentication acts raise suspicion about the propriety of the information being transmitted, a supplemental confirmation may be requested of the mobile device 102. For example, the supplemental confirmation may be provided in the form of a security question (e.g., “What is your dog's name?” or “What is your mother's maiden name?”) that is set up upon the initialization of a user profile associated with the mobile device 102. Additionally or alternatively, the supplemental confirmation may request the user to select a photo from their mobile device 102, so that the user authentication module 174 can then verify that it matches an expected photo that either the user has provided earlier or that a system administrator can approve.

If authentication is successful, the method may proceed to step 230.

At step 230, the intermediate server 170 may relay the information associated with the user interaction to the CRM application 152, to log the information with a customer record linked to the customer identifier.

As noted, the transmitted information may also include a native customer identifier used by the CRM application 152 to identify a customer record accessible by the CRM application 152. As discussed above, the mobile device 102 may include an external identifier database 116 that stores the native customer identifiers used by the CRM application 152 to identify customer records. In such embodiments, the linking module 114 of the mobile device 102 may be configured to retrieve the native customer identifier used by the CRM application 152 and include it in the transmitted information.

As illustrated, step 225 is shown in dotted outline to illustrate that it is an optional step. For example, user authentication may have already occurred prior to the method of FIG. 2 being performed. In such case, the steps of authenticating the PIM application for use with the CRM application (step 225) may not need to take place when performing the method illustrated in FIG. 2.

In an alternate embodiment, the PIM application 104 may not communicate with the CRM application 152 using the intermediate server 170 as an intermediary. Instead, the mobile device 102 may be configured to communicate with the external services directly. For example, the linking module 114 (as shown in FIG. 1) may be configured to communicate directly with the cloud-based CRM application 152′ or the cloud-based DRM application 154′ directly without processing any communication through the intermediate server 170.

In such embodiments, the intermediate server 170 may still operate in a supporting role by, for example, performing user authentication or providing external identifier information from the external identifier cache 172. If the intermediate server 170 were to provide a supporting user authentication role, the user authentication module 174 may be configured to return a security token to the PIM application 104, which may then be used by the PIM application 104 to prove authentication to the CRM application 152, 152′ directly.

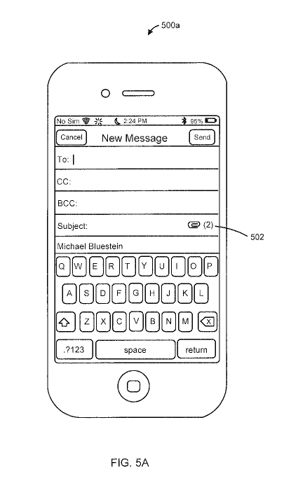

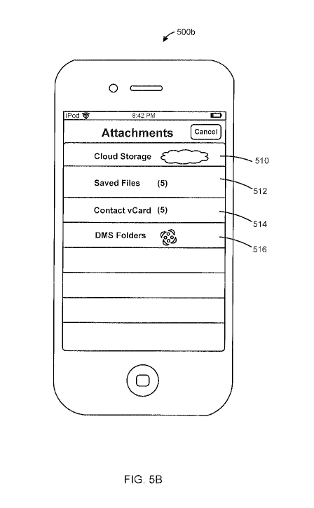

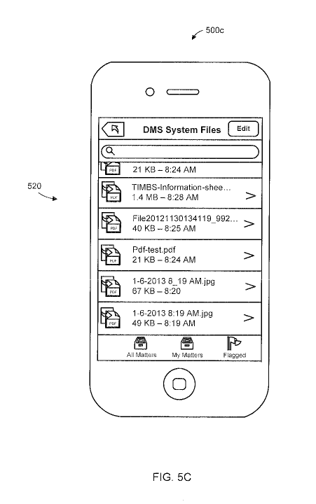

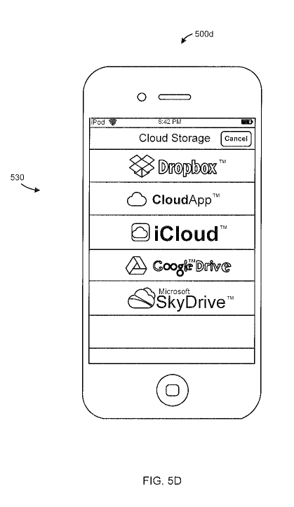

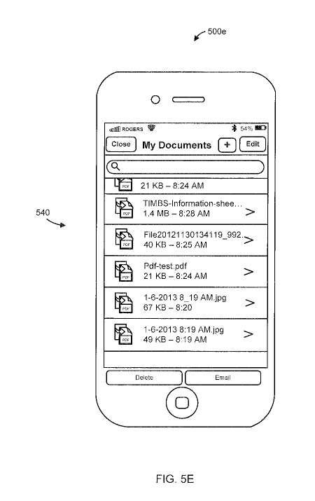

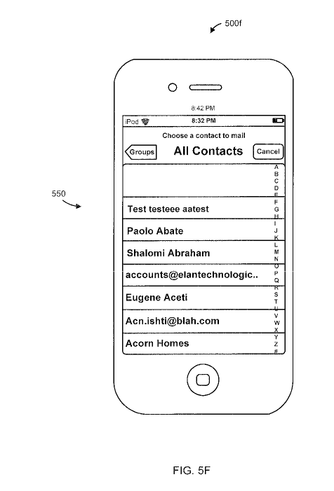

Referring to FIG. 3, shown there generally as 300 is a flowchart diagram illustrating the steps of providing information associated with a user interaction to a Document Management System (DMS) application, in accordance with an embodiment of the present disclosure. As will be understood, the steps performed in FIG. 3 may be similar to those illustrated in FIG. 2, with the difference being that the external service is a DMS application as opposed to a CRM application. Reference will again simultaneously be made to the various components described above in FIG. 1. Reference will simultaneously also be made to the various screenshots of FIG. 5A-5F.

As mentioned above, a DMS application 154 may be a server application that stores electronic documents, and may allow users to track different versions of documents as created or modified by different users. When a user is using their mobile device 102, they may desire to access a document stored in the DMS application 154 provided by their organization. Take, for example, the example discussed above where the user interaction being tracked is the composing of an email. In this scenario, the user may desire to attach a document from the DMS application 154 to the email they are composing.

At step 305, the PIM application 104 may receive an input that initiates a user interaction on a mobile device. At step 310, the tracking module 112 may track, information associated with the user interaction. These steps may be performed in a fashion that is similar to steps 205 and 210 of FIG. 2 respectively.

For example, continuing on with the example where the user interaction is the composing of an email, the information in this case may be information indicating that a user interface option to attach a document has been selected. Referring briefly to FIG. 5A, shown there generally as 500a is an example screenshot on the user interface of a mobile device 102, when a user has selected to compose an email. As illustrated, the user interface may be provided with an option 502 that, when selected, allows a user to select a document to attach to the email.

Referring back to FIG. 3, at step 315, a document identifier associated with the user interaction may be determined. For example, this step may be performed by configuring the tracking module 112 to present a user interface that allows a user to select a document from various document sources. In various embodiments, the document identifier may be a Uniform Resource Locator (URL), a filepath, a structured query or some other data that allows a desired document to be located within the DMS application 154.

In the example where the user interaction is the composing of an email at the mobile device 102, the mobile device 102 may present a user interface that allows the user to select the source of the document that is to be attached to the email being composed. Referring briefly to FIG. 5B, shown there generally as 5006 is an example screenshot on the user interface of a mobile device 102 that allows a user to select the source of the document to be attached. As illustrated, the user interface may provide options to select four different sources: a ‘Cloud Storage’ option 510 (e.g., selecting a file from a cloud-based DMS application 154′), a ‘Saved Files’ option 512 (e.g., selecting a file stored locally on the mobile device 102), a ‘Contact vCard’ option 514 (e.g., selecting an electronic business card in the ‘vCard’ format for a contact stored on the mobile device 102), and a ‘DMS Folders’ option 516 (e.g., selecting a file stored on a DMS application 154 within the secure network 140).

Continuing on with the example, the mobile device 102 may receive input that selects the ‘DMS Folders’ option 516.

To determine the document identifier, the mobile device 102 may retrieve a list of available files from the DMS application 154. This list of files may then be presented in a user interface of the mobile device 102. The mobile device 102 may then receive input that selects a particular document that is stored on the DMS application 154. The selection may result in the generation of the document identifier (e.g., a filepath, URL, or some structured query into a DMS application 154) for the document that is desired to be attached to an email.

Referring briefly to FIG. 5C, shown there generally as 500c is an example screenshot on the user interface of a mobile device 102 that displays a list of files available to be selected on a DMS application. As illustrated, the list of files 520 may have been retrieved from the DMS application 154, and displayed for selection in the user interface of the mobile device 102.

The mobile device 102 may be configured to retrieve this list via the intermediate server 170, which may in turn request the list of available documents from the DMS application 154 within the secure network 140. The presence of the intermediate server 170 may standardize the interface of different vendors of DMS applications 154, so that the mobile device 102 need only communicate with the intermediate server 170 to retrieve files stored on DMS applications 154 from different vendors. This may ease deployment of mobile devices 102 in an organization, as the mobile devices 102 need only send a standardized message to the intermediate server 170 without needing to be specifically configured to communicate with a particular DMS application 154.

It will be understood that the document identifier may be determined regardless of whether the DMS application 154 stores its files in a “structured” or “unstructured” fashion.

As will be understood, files that are stored in a structured fashion may be required to follow strict rules are about how they are organized so that files can be accessed in a uniform way. Files stored in a structured DMS application 154 may be provided with metadata (e.g., eXtensible Markup Language (XML) tags according to a defined document type definition (DTD) or schema) that formalize how the files are stored within the DMS application 154. An unstructured DMS application 154, on the other hand, may have no such constraints on how files are stored. Examples of structured DMS applications 154 may include OpenText™ or Microsoft Sharepoint™, and examples of unstructured DMS applications 154 may include Apple™ iCloud™ or DropBox™. The intermediate server 170 may be configured to return the list of files from either structured or unstructured sources, and allow a mobile device 102 to present a uniform list of files for selection in a user interface.

Referring back to FIG. 3, at step 320, the mobile device may transmit the information associated with the user interaction to the intermediate server 170. This information may include the document identifier determined at stop 315. As with step 220 in FIG. 2 above, the information may also include credential information if user authentication has not been performed.

At step 325, the intermediate server 170 may authenticate the PIM application 104 for use with the DMS application 154. Step 325 may be performed in a manner that is similar to step 225 in FIG. 2, except that authentication is being performed for a DMS application 154 instead of CRM application 152.

At step 330, the intermediate server 170 may relay the information associated with the user interaction to the DMS application 154, to retrieve a document identified by the document identifier.

As discussed below, in cases where the information about the user interaction includes a request to attach a document from the DMS application 154 to an email that is being composed on the mobile device 102, the DMS application 154 may subsequently provide the requested document (as identified by the document identifier) back the mobile device 102.

While the above example has been discussed with respect to the selection of a file from a DMS application 154 within a secure network 140, the mobile device 102 may provide options to select a file from other sources. As discussed above with respect to FIG. 5B, in addition to a DMS application 154, the mobile device 102 may allow the selection of a document from a cloud-based DMS application 154′, a file stored locally on the mobile device 102, and/or an electronic business card (e.g., a vCard) associated with a contact stored on the mobile device 102. Screenshots for these options are shown in FIGS. 5D-5F, and will now be briefly described.

Referring briefly to FIG. 5D, shown there generally as 500d is an example screenshot on the user interface of a mobile device 102 that displays a list of cloud-based DMS applications 154′ that may be selected. As illustrated, a number of different vendors 530 of cloud-based DMS applications 154′ (e.g., DropBox™, Microsoft SkyDrive™, and Google™ Drive) are presented. This screen may be displayed to allow a user to select the vendor of the cloud-based DMS application 154′ that is storing the document that they would like to attach to an email. After one of the cloud-based DMS applications 154 have been selected, a user authentication user interface may be displayed to allow the user to login to the cloud-based DMS application 154′. Once the user has been authenticated, a list of files stored on the cloud-based DMS application 154′ may be presented. The list of files stored on the cloud-based DMS application 154′ may be retrieved in a manner similar to that which was discussed above for the DMS application 154 within a secure network 140.

Referring to FIG. 5E, shown there generally as 500e is an example screenshot on the user interface of a mobile device 102 that displays a list of locally-stored files that may be selected. As illustrated, the various files 540 may be retrieved from a local data store of the mobile device 102, and displayed in the user interface. One or more of the files 540 may then be selected to be attached to the email that is being composed.

Referring to FIG. 5F, shown there generally as 500f is a list of contacts, for which an electronic business card can be attached to an email being composed. As illustrated, the various contacts 550 may be retrieved from the address book function 126 of the PIM application 104 (as shown in FIG. 1), and displayed in the user interface. One or more of the contacts may then be selected. Electronic business cards for the selected contact(s) may then be attached an email being composed.

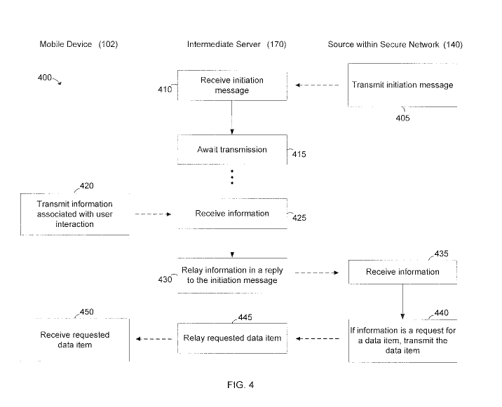

Referring to FIG. 4, shown there generally as 400 is a flowchart diagram illustrating the steps of allowing a mobile device to communicate with a source within a secure network, in accordance with an embodiment of the present disclosure.

As discussed earlier, the intermediate server 170 may act as a server that relays information between the mobile device 102 and the external services within the secure network 140. This configuration may be desirable, for example, to offload certain tasks that may typically need to be performed by the external service to the intermediate server 170. Aspects of how security may be achieved using the intermediate server will now be discussed in greater detail.

At step 405, an initiation message may be transmitted from a source within the secure network 140. The source within the secure network 140 that transmits the initiation message may be the integration system 142 that is configured to communicate with the intermediate server 170. As discussed above, when a message is received by the integration system 142 from the intermediate server 170, the integration system 142 may typically further relay information from the immediate server 170 to an external service within the secure network 140 (e.g., the CRM application 152 or the DMS application 154) that is capable of processing the information. This may be performed, for example, by the integration system 142 accessing APIs made available by the external service. At step 405, however, the integration system 142 is not receiving information from the intermediate server 170, but rather, is transmitting an outbound message to the intermediate server 170.

Moreover, the CRM application 152 and/or the DMS application 154 may typically not be within the control of the system of the present disclosure (e.g., when the applications are cloud-based, as discussed above). As such, configuring the initiation message to originate from the integration system 142 may result in an easier deployment, because it may be easier to configure the integration system 142 than the external services.

Nevertheless, in alternate embodiments, it may be possible to configure the external services themselves, such that the source within the secure network 140 that transmits the initiation message may actually be the external service itself.

At step 410, the initiation message is received at the intermediate server 170. The initiation message may have been transmitted through the firewall 150 (as shown in FIG. 1). As will be understood, the firewall 150 may typically protect the servers within the secure network 140 by preventing unauthorized or unexpected incoming communication from reaching internal servers. However, since the initiation message is an outgoing message being sent from within the secure network 140, it would typically be allowed to be sent through the firewall 150 to the intermediate server 170.

At step 415, the intermediate server 170 awaits a transmission from the mobile device.

At step 420, the mobile device 102 may transmit information associated with a user interaction occurring on the mobile device to the intermediate server 170. The information associated with the user interaction may be similar to that which was discussed above with regards to information that may be transmitted to an external service. Accordingly, step 420 may generally correspond to step 220 in FIG. 2 and step 320 in FIG. 3.

At step 425, the intermediate server 170 receives the information associated with the user interaction from the mobile device 102.

As discussed above with respect to steps 225 in FIG. 2 and step 325 in FIG. 3, in some embodiments, the intermediate server 170 may authenticate the mobile device 102 for access to the source within the secure network 140, prior to the relaying in step 430. If authentication fails, an error message may be returned to the mobile device 102, and the method may not continue to step 430. If authentication succeeds, the method may proceed to step 430.

At step 430, the intermediate server 170 relays the information received from the mobile device 102 to the source within the secure network 140. This step may generally correspond to step 230 in FIG. 2 and step 330 in FIG. 3. This relaying may be performed by embedding the information received from the mobile device 102 in a reply to the initiation message (as was transmitted by the source within the secure network at step 405).

By embedding the information received from the mobile device 102 in a reply to the initiation message, the intermediate server 170 effectively allows the mobile device 102 to transmit information to the source within the network 140 without requiring explicit configuration of the firewall 150. As will be understood, the firewall 150 may typically prohibit or block unfamiliar or unexpected incoming communications from reaching sources within the secure network 140. Traditionally, if communication is known to be expected from a particular application, a system administrator at the secure network 140 may configure the firewall 150 to allow specific types of communications through to designated servers within the secure network 140. (For example, the system administrator may open port 80 for Hypertext Transfer Protocol data, and allow the data that comes in port 80 through to a web server within secure network 140.) Accordingly, if the mobile device were to transmit information associated with user interaction to the secure network 140, a system administrator would traditionally be required to open a particular port in the firewall 150 to allow the communication through. The need for additional configuration may be avoided in the embodiment shown in FIG. 4.

By including the information that the mobile device 120 is attempting to transmit in a reply to the initiation message, the likelihood that the transmitted information will be blocked by the firewall 150 will be reduced. While a firewall 150 may typically block incoming communications from an unfamiliar source, the reply message would likely not be blocked because it is coming from a known source (e.g., a source that a server within the secure network 140 has already contacted). Accordingly, the reply message may be allowed through the firewall 150 without requiring any explicit configuration of the firewall 150 that would otherwise be necessary to allow the mobile device 102 to communicate with the source within the secure network 140.

At step 435, the source within the secure network 140 receives the information relayed at step 430. As noted, if the source within the secure network 140 is the integration system 142, the integration system 142 may further relay the information to the appropriate external service for processing. This may be performed, for example, by the integration system 142 accessing the internal API of the external service that would not otherwise be externally accessible.

At step 440, if the information includes a request for a data item, the source within the secure network 140 may transmit the requested data item to the intermediate server 170. For example, as discussed above, the request may be generated when an email is being composed using the PIM application 104 on the mobile device 102, and the request may be a request to attach a document stored in a DMS application 154 to the email.

At step 445, the requested data item is received at the intermediate server 170 and relayed to the mobile device 102. In the example where the data item is a document being stored on the DMS application 154, the requested document may be transmitted from a DMS application 154 to the integration system 142 (which then forwards the document). The document may be received at the intermediate server 170 and then relayed to the mobile device 102.

At step 450, the mobile device 102 receives the requested data item. In the case where the requested data item is a document to be attached to an email being composed at the mobile device 102, the PIM application 104 may receive the requested document and attach it to the email being composed.

The present invention has been described here by way of example only. Various modification and variations may be made to these exemplary embodiments without departing from the scope of the invention, which is limited only by the appended claims.

For example, with respect to FIG. 1, the information associated with the user interaction may be transmitted from the mobile device 102 at various times relative to the user interaction itself. In various embodiments, the information associated with the user interaction may be transmitted upon completion of the user interaction, or in some cases, prior to the completion of the user interaction.

Particularly, the timing of when the information is transmitted from the mobile device 102 may vary depending on the nature of the information to be transmitted. For example, if the information to be transmitted includes the duration of the user interaction (e.g., the time spent by the user reading or composing an email), then the information would only be transmitted upon the completion of the user interaction. Alternatively, if the user interaction is to select an a document from a DMS application 154 for attachment to an email, then the information associated with the user interaction (e.g., a request for a document from the DMS application 154) may be transmitted prior to the completion of the user interaction of composing an email.

In another modification, although FIG. 1 is illustrated with the external identifier database 116 being provided at the mobile device 102, it will be understood that the external identifier database 116 may be omitted, and the looking up of a native external identifier for an external service may take place at the intermediate server 170 using the external identifier cache 172. In further embodiments, the external identifier database 116 and the external ID cache 172 may both be omitted, such that they are not provided at either the mobile device 102 or the intermediate server 170 respectively. In such embodiments, no native external identifier for the external service may be transmitted to integration system 142, and the integration system 142 may be configured to determine an appropriate external identifier. Alternatively, the external service itself may be configured to identify the relevant record(s) stored at the external service based solely on data from the user interaction alone.

Moreover, still with respect to FIG. 1, although illustrated as being separate modules, in some embodiments, the tracking module 112 and the linking module 114 may be provided together in a single software or hardware module. In further embodiments, the operations of these two modules may be divided into three or more software or hardware modules.

In yet another modification, the integration system 142 within the secure network 140 of FIG. 1 may be configured to provide further functionality in addition to the translation and relaying of communication between the intermediate server 170 and the external services. Some of this functionality may, for example, improve performance by reducing the amount of data that needs to be transmitted.

For example, consider a scenario where the information transmitted from the linking module 114 of the mobile device 102 is a request to store an attachment received in an email onto the DMS application 154. In this scenario, the request to store the attachment may be sent from the mobile device 102 to the intermediate server 170, which then relays the request to the integration system 142 as discussed above. However, instead of simply relaying the request to the DMS application 154, the integration system 142 may be configured to copy the attachment of the email stored on the PIM server 158 to the DMS application 154 to satisfy the request.

This additional functionality of the integration system may result in the actual attachment not needing to be transmitted from the mobile device 102. As a result, potential costs and uncertainty associated with transmitting the attachment may be avoided, and performance may be improved.

As noted, the systems and methods disclosed herein are presented only by way of example and are not meant to limit the scope of the subject matter described herein. Other variations of the systems and methods described above will be apparent to those in the art and as such are considered to be within the scope of the subject matter described herein. For example, it should be understood that acts and the order of the acts performed in the processing described herein may be altered, modified and/or augmented yet still achieve the desired outcome.

As used herein, the wording “and/or” is intended to represent an inclusive-or. That is, “X and/or Y” is intended to mean X or Y or both. Moreover, “X, Y, and/or Z” is intended to mean X or Y or Z or any combination thereof.

We claim:

1. A mobile device comprising a processor and a memory storing instructions which, when executed by the processor, cause the processor to provide a Personal Information Manager (PIM) application, the PIM application comprising:
a tracking module for tracking information associated with a user interaction occurring on the mobile device; and
a linking module for communicating with an external service unrelated to the PIM application, wherein the external service is capable of processing the information associated with the user interaction;
wherein,
the tracking module is configured to provide the information associated with the user interaction to the linking module, and
the linking module is configured to transmit the information to be processed by the external service.

2. The mobile device of claim 1, wherein the linking module communicates with the external service via an intermediate server, and the intermediate server relays the information from the mobile device to the external service.

3. The mobile device of claim 1, wherein the user interaction comprises interaction with at least one function of the PIM application, the at least one function being selected from the group consisting of: an email function, a calendar function, a notes function, an address book function, and a to-do list function.

4. The mobile device of claim 1, wherein the information associated with the user interaction comprises a duration of the user interaction.

5. The mobile device of claim 1, wherein the tracking module is configured to determine a customer identifier associated with the user interaction, and the information transmitted to the external service comprises the customer identifier.

6. The mobile device of claim 5, wherein the external service comprises a Customer Relationship Management (CRM) application that is configured to log the transmitted information with a customer record linked to the customer identifier.

7. The mobile device of claim 5, wherein the user interaction comprises interaction with an email function of the PIM application, and wherein the customer identifier is determined by identifying an email address provided in an email.

8. The mobile device of claim 1, wherein the tracking module is configured to determine a document identifier associated with the user interaction, and the information transmitted to the external service comprises the document identifier.

9. The mobile device of claim 8, wherein the external service comprises a Document Management System (DMS) application that is configured to retrieve a document identified by the document identifier.

10. The mobile device of claim 8, wherein the user interaction comprises interaction with an email function of the PIM application, and wherein the document identifier locates a file that is to be attached to an email.

11. The mobile device of claim 1, wherein prior to the linking module transmitting the information to the external service, the linking module is configured to authenticate the PIM application for use with the external service.

12. The mobile device of claim 11, wherein when authenticating the PIM application for use with the external service, the linking module sends credential information to an intermediate server that is separate from the external service.

13. A method of tracking user interactions on a mobile device, the method comprising:
receiving, at a Personal Information Manager (PIM) application on the mobile device, an input that initiates a user interaction;
tracking, using the PIM application, information associated with the user interaction;
determining an identifier for data on an external service, the external service being unrelated to the PIM application, and the identifier being associated with the user interaction; and
transmitting the identifier and the information associated with the user interaction to an intermediate server;
wherein the intermediate server relays the information to the external service, and wherein the external service is capable of processing the information associated with the user interaction in conjunction with the data on the external service identified by the identifier.

14. A method of allowing a mobile device to communicate with a source within a secure network, the method comprising:
receiving an initiation message from the source within the secure network;
awaiting a transmission, from the mobile device, of information associated with a user interaction occurring on the mobile device;
receiving the information associated with the user interaction; and
in response to the receiving, relaying the information to the source within the secure network, wherein the relaying is performed by including the information in a reply to the initiation message.

15. The method of claim 14, wherein the method is performed by an intermediate server that is in communication with both the mobile device and the source within the secure network.

16. The method of claim 14, wherein the information comprises a request for a data item from the source within the secure network, and the method further comprises:
receiving the requested data item from the source within the secure network; and
relaying the requested data item to the mobile device.

17. The method of claim 14, wherein prior to relaying the information to the source within the secure network, the method further comprises authenticating the mobile device.

18. The method of claim 14, wherein the source within the secure network comprises an integration system that is configured to further relay the information to an external service that is capable of processing the information.

19. The method of claim 18, wherein the external service that is capable of processing the information comprises a Document Management System (DMS) application.

20. The method of claim 18, wherein the external service that is capable of processing the information comprises a Customer Relationship Management (CRM) application.
